(19) United States
(12) Patent Application Publication
(10) Pub. No.: US 2023/0259990 A1
(43) Pub. Date: Aug. 17, 2023

(54) Hybrid Machine Learning and Natural Language Processing Analysis for Customized Interactions

(71) Applicant: STATE FARM MUTUAL AUTOMOBILE INSURANCE COMPANY, Bloomington, IL (US)

(72) Inventors: Manish Limaye, Gilbert, AZ (US); Maia Petee, Sandy Springs, GA (US)

(21) Appl. No.: 17/671,276

(22) Filed: Feb. 14, 2022

(51) Int. Cl. G06Q 30/02; G06N 20/00; G06K 9/62

(52) U.S. Cl. CPC G06Q 30/0281; G06N 20/00; G06K 9/6256

(57) ABSTRACT

A method is provided, comprising: obtaining training data including historical transcripts from historical user interactions, and indications of workflow statuses associated with each of the historical transcripts; training a machine learning model to classify transcripts from user interactions based on workflow status using the training data; applying the trained machine learning model to a new transcript from a new user interaction in order to identify a workflow status associated with the new transcript; generating a message to a user associated with the new user interaction based on the identified workflow status; analyzing the new transcript using a natural language processing algorithm to identify one or more triggers associated with the new transcript; modifying one or more parameters associated with the generated message to the user based on the one or more triggers associated with the new transcript; and transmitting the message to a device associated with the user.

### FIELD OF THE INVENTION

The present disclosure generally relates to analysis of user interactions, and more particularly, to a hybrid machine learning and natural language processing analysis system for customized user interactions.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Currently, customer interactions are often performed at static times (e.g., based on predetermined timers) according to automated processes. For example, a reminder to a customer to perform a certain task may be sent automatically at a predetermined time. However, the customer may already have performed the task via a different communication channel than that which is monitored by the system handling the reminders, and/or the customer may have indicated a preference for receiving a follow-up after a certain time or via a certain communication channel. If the customer receives a communication at a time or via a channel that the customer has previously indicated a dislike of, or receives a communication that no longer applies to where the customer is within a process, the customer may become annoyed.

### SUMMARY

In an embodiment, a computer-implemented method, comprising: obtaining, by one or more processors, training data including historical transcripts from a plurality of historical user interactions, and indications of workflow statuses associated with each of the historical transcripts; training, by the one or more processors, a machine learning model to classify transcripts from user interactions based on workflow status using the training data; applying, by the one or more processors, the trained machine learning model to a new transcript from a new user interaction in order to identify a workflow status associated with the new transcript; generating, by the one or more processors, a message to a user associated with the new user interaction based on the identified workflow status associated with the new transcript from the new user interaction; analyzing, by the one or more processors, the new transcript using a natural language processing algorithm to identify one or more triggers associated with the new transcript; modifying, by the one or more processors, one or more parameters associated with the generated message to the user based on the one or more triggers associated with the new transcript; and transmitting, by the one or more processors, the message to a device associated with the user.

In another embodiment, a system is provided, comprising one or more processors, and a memory storing instructions that, when executed by the one or more processors, cause the one or more processors to: obtain training data including historical transcripts from a plurality of historical user interactions, and indications of workflow statuses associated with each of the historical transcripts; train a machine learning model to classify transcripts from user interactions based on workflow status using the training data; apply the trained machine learning model to a new transcript from a new user interaction in order to identify a workflow status associated with the new transcript; generate a message to a user associated with the new user interaction based on the identified workflow status associated with the new transcript from the new user interaction; analyze the new transcript using a natural language processing algorithm to identify one or more triggers associated with the new transcript; modify one or more parameters associated with the generated message to the user based on the one or more triggers associated with the new transcript; and transmit the message to a device associated with the user.

In still another embodiment, a non-transitory, computer-readable medium is provided, storing instructions that, when executed by one or more processors, cause the one or more processors to: obtain training data including historical transcripts from a plurality of historical user interactions, and indications of workflow statuses associated with each of the historical transcripts; train a machine learning model to classify transcripts from user interactions based on workflow status using the training data; apply the trained machine learning model to a new transcript from a new user interaction in order to identify a workflow status associated with the new transcript; generate a message to a user associated with the new user interaction based on the identified workflow status associated with the transcript from the new user interaction; analyze the new transcript using a natural language processing algorithm to identify one or more triggers associated with the new transcript; modify one or more parameters associated with the generated message to the user based on the one or more triggers associated with the new transcript; and transmit the message to a device associated with the user.

### BRIEF DESCRIPTION OF THE DRAWINGS

FIG. 1 illustrates a block diagram representing an example hybrid machine learning and natural language processing analysis system for customized interactions, in accordance with some examples provided herein.

FIG. 2 illustrates an example transcript of several example messages to a user, as may be generated by the hybrid machine learning and natural language processing analysis system for customized interactions of FIG. 1, in accordance with some examples provided herein.

FIG. 3 illustrates a flow diagram representing an exemplary method, as may be implemented by the hybrid machine learning and natural language processing analysis system for customized interactions of FIG. 1, in accordance with some examples provided herein.

### DETAILED DESCRIPTION

The techniques provided herein relate to using a hybrid machine learning and natural language processing (NLP) system to customize interactions with a customer. A machine learning model may be trained using text transcripts of customer interactions, such as online chat transcripts, text messages, and phone call transcripts. The machine learning model may be trained to classify a transcript into a status for a customer workflow. For example, in a case where the customer workflow is an insurance claim, the machine learning model may be trained to identify, based on a transcript, whether a status of a customer's claim is at an estimate stage, a repair stage, or a complete stage. The particular statuses that the machine learning model may be trained to identify may vary with implementation (e.g., statuses related to booking a hotel room, making a payment, maintaining an insurance policy).

In operation, the system may detect an event corresponding to a new transcript for the customer. The new transcript may be from one of many different customer channels—e.g., email, SMS text, phone transcript, etc. The trained machine learning model may be applied to the transcript to classify the transcript into a category indicating the status of a customer workflow. In addition, a natural language processing algorithm may also be applied to the transcript to identify particular triggers present within the transcript. These triggers may indicate the presence of conditions under which the system should modify a communication for the customer. For example, the triggers may be dates or times, indicating that the customer does not desire customer interactions within a certain time period. As another example, the triggers may indicate a preferred communication channel of the customer (e.g., email, text, or live agent). The natural language processing may include regular expression identification and may incorporate a bag-of-words model.

Based on the output of the machine learning model and detected triggers within the transcript (i.e., on a combination of the machine learning model output and the natural language processing output), a communication with the customer may be customized. In particular, the timing, content, and/or channel of the communication may be adjusted based on the status of the customer workflow and on identified triggers. For example, if the machine learning model indicates that the customer is at the repair stage of an insurance claim, but that the customer will be out of town for seven days, the system can prepare communications for the customer related to repair, but delay such communications for seven days.

Advantageously, the techniques provided herein dynamically respond to where a customer is in a particular workflow, in a manner that is responsive to customer preferences. Currently, as discussed above, customer interactions are often performed at static times (e.g., based on predetermined timers) according to automated processes. For example, a reminder to a customer to perform a certain task may be sent automatically at a predetermined time. However, the customer may already have performed the task via a different communication channel than that which is monitored by the system handling the reminders, and/or the customer may have indicated a preference for receiving a follow-up after a certain time or via a certain communication channel. If the customer receives a communication at a time or via a channel that the customer has previously indicated a dislike of, or receives a communication that no longer applies to where the customer is within a process, the customer may become annoyed. In contrast, the techniques provided herein take in transcripts from any communication channel of the business. Thus, the techniques provided herein take into account data from any channel in which the customer interacts with the business (e.g., email, phone, and/or text). Further, the techniques provided herein identify where a customer is within a particular customer workflow or process (e.g., at what stage within an insurance claims process the customer is in) and any indicated customer preferences based on transcripts, and customize content, timing, and/or channel of the message accordingly.

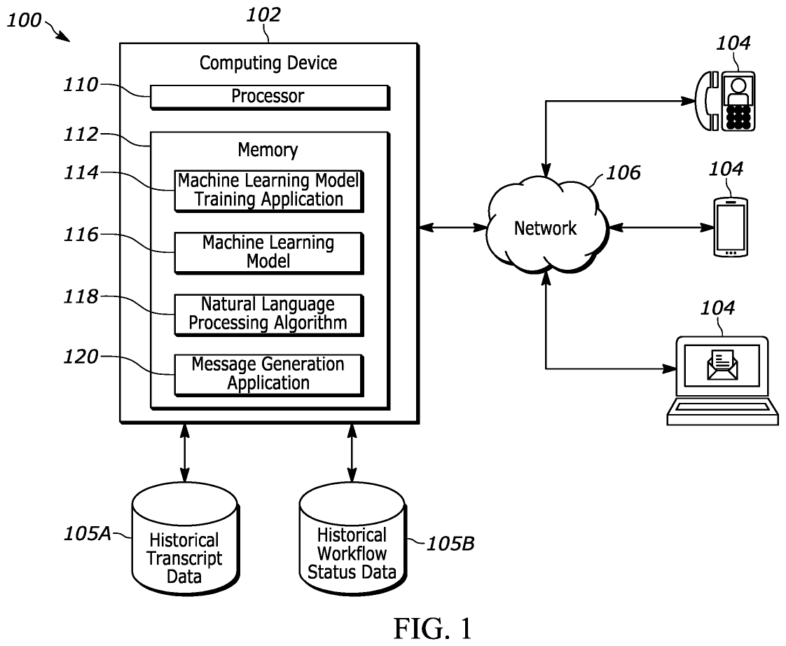

FIG. 1 is a block diagram of a hybrid machine learning and natural language processing analysis system 100 for customized interactions, in accordance with some examples provided herein. The high-level architecture illustrated in FIG. 1 may include both hardware and software applications, as well as various data communications channels for communicating data between the various hardware and software components, as is described below.

The system 100 may include a computing device 102 configured to communicate with one or more user devices 104, which may include, e.g., user telephone devices, user personal mobile devices, user tablets, laptops, or other computing devices, etc., as well as one or more databases 105A, 1056, via a network 106, which may be a wired or wireless network.

The computing device 102 may include one or more processors 110 and a memory 112 (e.g., volatile memory, non-volatile memory). The memory 112 may be accessible by the one or more processors 110 (e.g., via a memory controller). The one or more processors 110 may interact with the memory 112 to obtain, for example, computer-readable instructions stored in the memory 112. The computer-readable instructions stored in the memory 112 may cause the one or more processors 110 to execute one or more applications, including a machine learning model training application 114, a machine learning model 116, a natural language processing algorithm 118, and/or a message generation application 120, stored on the memory 112. Although the computing device 102 is discussed herein as one device, in some examples multiple computing devices 102 may perform the operations described as being performed by the computing device 102. For instance, processors 110 of one computing device 102 may execute the applications 114 and 116, and the processors 110 of another computing device may execute the applications 118 and 120, in an example.

In any case, the computer-readable instructions stored in the memory 112 may cause the one or more processors 110 to execute a machine learning model training application 114 to train a machine learning model 116 stored on the memory 112. The machine learning model training application 114 may train the machine learning model 116 using training data from databases 105A, 1056.

For instance, database 105A may store historical transcript data from historical user interactions, and database 1056 may store workflow status data representative of a workflow status associated with each historical user interaction. The historical transcript data stored in the database 105A may include historical transcripts from user interactions with an automated virtual assistant, as well as historical transcripts from user interactions with other individuals. Moreover, the historical transcript data stored in the database 105A may include historical transcripts from user interactions over various communication channels, such as, e.g., a telephone call communication channel, a text message communication channel, an email communication channel, an online chat message communication channel, etc. The workflow status database 1056 may store an indication of a workflow status associated with each historical transcript stored in the database 105A. In some examples, the workflow status database 1058 may also include an indication of a workflow associated with each historical transcript stored in the database 105A (e.g., when the historical transcripts in the database 105A correspond to multiple workflows, as well as multiple statuses within each workflow). For example, possible workflows may include a workflow for an insurance claim, booking a hotel room or rental car, making a payment, maintaining an insurance policy, etc. Each workflow may include a plurality of respective workflow statuses. For instance, where the workflow is an insurance claim, possible workflow statuses may include an estimate stage, meaning that the claim is still processing, a repair stage, in which a vehicle is at a repair shop or being scheduled for repairs, or a complete stage, meaning that no further action is required. In some examples, a given historical transcript may be associated with multiple workflow statuses. Moreover, in some examples, depending on the length of the transcript, a first portion or other sub-part of a historical transcript may be associated with a first workflow status, while another (e.g., second) portion or other sub-part of the historical transcript may be associated with a second workflow status, e.g., if the user moves through multiple stages of a workflow during a given interaction. Of course, while databases 105A and 1058 are shown as two separate databases in FIG. 1, in some examples, a single database may store the data described herein as being stored by the two separate databases 105A and 1058.

In any case, machine learning model training application 114 can train the machine learning model 116 using deep learning, supervised learning, unsupervised learning, reinforcement learning, or any other suitable technique to analyze the training data from the database 105A, 1058. Over time, as the machine learning model training application 114 trains machine learning model 116, the trained machine learning model 116 may learn to predict or identify workflow statuses associated with user interactions, i.e., in order to classify new transcripts from new user interactions as being associated with a particular workflow status or workflow statuses.

Furthermore, the computer-readable instructions stored in the memory 112 may cause the one or more processors 110 to execute a natural language processing algorithm 118. The natural language processing algorithm 118 may include regular expression identification and may incorporate a bag-of-words model. In particular, the natural language processing algorithm 118 may be configured to analyze transcripts from user interactions, in plain English, in order to identify one or more triggers in the transcripts from the user interactions. These triggers may indicate the presence of conditions communicated by the user during the user interaction. For example, the triggers may be dates or times, indicating that the user does not desire interactions within a certain time period. For instance, the transcript may include a transcription of a user stating “I'll be on vacation next week,” “I'm at work 9-5 on weekdays,” “I'm free tomorrow,” “check back with me next week,” etc. The natural language processing algorithm 118 may detect triggers in the transcripts of these statements, indicating, for instance, that the user does not desire interactions during the next calendar week, that the user does not desire interactions during the 9-5 timeframe on Mondays, Tuesdays, Wednesdays, Thursdays, or Fridays, that the user desires interactions on the next calendar day, that the user desires interactions the following week, etc.

As another example, the triggers may indicate a preferred communication channel of the user (e.g., email, text, telephone call, online chat, etc.), and/or a preferred communicator (e.g., automated virtual assistant, live agent, etc.). For instance, the transcript may include a transcription of a user stating, e.g., “text is the best way to reach me,” “I'd prefer to speak with a live agent,” “please do not call me,” “let's chat online,” etc. The natural language processing algorithm 118 may detect triggers in the transcripts of these statements, indicating, for instance, that the user does prefers text message communications, that the user prefers live agent communications rather than automated virtual assistant communications, that the user does not prefer to be contacted via phone call, that the user prefers to chat online, etc.

Moreover, the computer-readable instructions stored in the memory 112 may cause the one or more processors 110 to execute a message generation application 120. The message generation application 120 may obtain new transcripts from new user interactions, e.g., from one or more user devices 104 via the network 106, and may generate and transmit messages to users based on the new transcripts. In particular, the message generation application 120 may apply the trained machine learning model 116 to a new user transcript in order to identify a workflow and/or a workflow status associated with the new user transcript. The message generation application 120 may then generate a message to a user associated with the new user transcript based on the identified workflow and/or workflow status associated with the new user transcript. For instance, if the identified workflow status associated with the new user transcript is at a repair stage of a vehicle insurance claim workflow, the message generation application 120 may generate a message to the user providing body shop details. As another example, if the identified workflow status associated with the new user transcript is at a replace stage of an insurance claim workflow, the message generation application 120 may generate a message to the user providing details on how to receive cash or a physical replacement for a vehicle.

Furthermore, the message generation application 120 may apply the natural language processing algorithm 118 to the new user transcript in order to identify any triggers present in the transcript. The message generation application 120 may then modify various parameters associated with the generated message based on the identified triggers. In some examples, the generated message may include default parameters, e.g., a default communication via text, at noon, from an automated virtual assistant. Moreover, the user interaction from which the transcript is obtained may be currently occurring over a particular communication channel (e.g., over the phone), at a particular time (e.g., at 8:00 AM on a Monday), or via a particular communicator (e.g., via a live agent communicator, or via an automated virtual assistant communicator). However, the message generation application 120 may modify and/or delay the timing or scheduling of the next generated message in the user interaction based on an identified trigger related to the user's availability or unavailability at certain dates/times. As another example, the message generation application may modify the communication channel of the next generated message in the user interaction based on an identified trigger related to the user's preference or ability (or inability) to receive messages via particular communication channels. As still another example, the message generation application may modify the communicator of a generated message based on an identified trigger related to user preferences for live agent communication or automated virtual assistant communication. That is, for instance, a user may indicate during a phone call that the user does not prefer to communicate via phone, and the next message generated by the message generation application 120 may be generated having a different communication channel parameter (e.g., via online chat, via email, via text, etc.). As another example, a user may indicate, during a conversation occurring on a weekday, that he or she prefers to be contacted on weekends only, and the next message generated by the message generation application 120 may be generated having a different timing or scheduling parameter (e.g., a weekend timing parameter). Furthermore, a user may indicate, during a conversation with a live agent, that he or she prefers to communicate with an automated virtual assistant, or vice versa, and the next message generated by the message generation application 120 may be generated having a different communicator parameter (e.g., a live agent communicator parameter, or an automated virtual assistant communicator parameter).

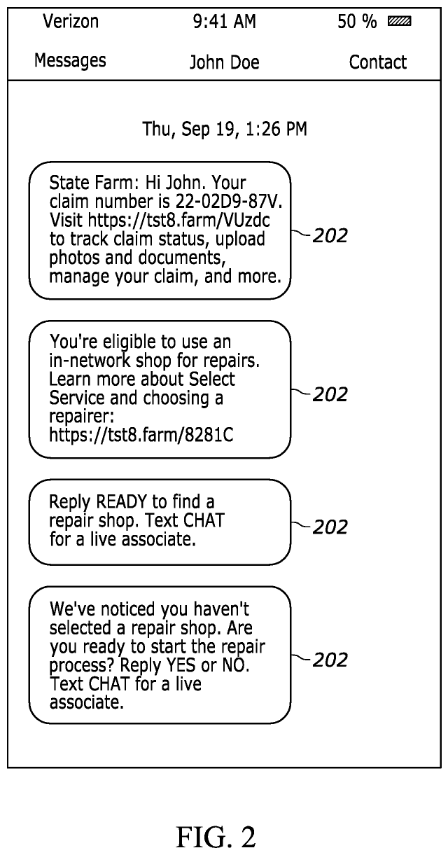

The message generation application 120 may then transmit the generated message to a user device 104 in accordance with these parameters. For instance, the message generation application 120 may transmit the generated message via a particular communication channel, using a particular communicator, or at a particular date and/or time, in accordance with the determined parameters. For example, FIG. 2 illustrates several example generated messages 202 transmitted to a user mobile device 104 via a text message communication channel, using an automated virtual assistant communicator. In examples in which the message generation application 120 generates a message having a live agent communicator parameter, the message or a portion thereof may be transmitted to a device associated with the live agent, who may in turn contact the user's device, in accordance with the determined timing and communication channel parameters.

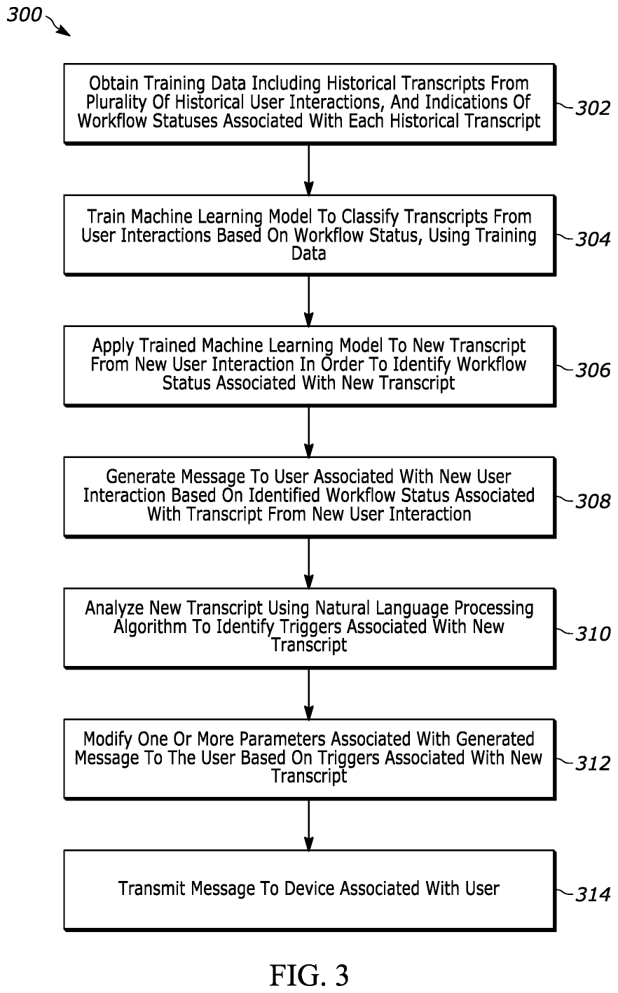

Additionally, in some examples, the computer-readable instructions stored on the memory 112 may include instructions for carrying out any of the steps of the method 300, described in greater detail below with respect to FIG. 3.

FIG. 3 is a flow diagram of an example method 300 as may be used in the system 100 of FIG. 1, in accordance with some examples provided herein. One or more steps of the method 300 may be implemented as a set of instructions stored on a computer-readable memory (e.g., memory 112) and executable on one or more processors (e.g., processors 110).

The method 300 may begin when training data is obtained (block 302), including historical transcripts from a plurality of historical user interactions, and indications of workflow statuses associated with each of the historical transcripts. A machine learning model may be trained (block 304) to classify transcripts from user interactions based on workflow status using the training data.

The trained machine learning model may be applied (block 306) to a new transcript from a new user interaction in order to identify a workflow status associated with the new transcript. For instance, in some examples, the new transcript from the new user interaction may be a transcript of a conversation between a user and an automated virtual assistant. In other examples, the new transcript from the new user interaction may be a transcript of a live conversation between a user and another individual (i.e., a live conversation between two individuals). Moreover, in some examples, the new transcript from the new user interaction may be a transcript of a user interaction across any of a variety of possible communication channels. For instance, the new transcript from the new user interaction may be a transcript of a telephone user interaction, an email user interaction, a text message user interaction, and/or an online chat user interaction.

A message to a user associated with the new user interaction may be generated (block 308) based on the identified workflow status associated with the transcript from the new user interaction. The new transcript may also be analyzed (block 310) using a natural language processing algorithm to identify one or more triggers associated with the new transcript.

One or more parameters associated with the generated message to the user may be modified (block 312) based on the one or more triggers associated with the new transcript. For instance, based on the triggers identified at block 310, a timing or scheduling parameter associated with the generated message to the user may be modified. As another example, based on the triggers identified at block 310, a communication channel parameter associated with the generated message to the user may be modified.

The generated message may be transmitted (block 314) to a device associated with the user. In particular, in some examples, the generated message may be transmitted in accordance with any parameters associated with the generated message, including parameters modified at block 312. For instance, the generated message may be transmitted in accordance with a timing or scheduling parameter, and/or in accordance with a communication channel or communicator parameter.

The following additional considerations apply to the foregoing discussion. With the foregoing, an insurance customer may opt-in to a rewards, insurance discount, or other type of program. After the insurance customer provides their affirmative consent, an insurance provider remote server may collect data from the customer's mobile device, smart home controller, or other smart devices—such as with the customer's permission or affirmative consent. The data collected may be related to smart home functionality (or home occupant preferences or preference profiles), and/or insured assets before (and/or after) an insurance-related event, including those events discussed elsewhere herein. In return, risk averse insureds, home owners, or home or apartment occupants may receive discounts or insurance cost savings related to home, renters, personal articles, auto, and other types of insurance from the insurance provider.

In one aspect, smart or interconnected home data, and/or other data, including the types of data discussed elsewhere herein, may be collected or received by an insurance provider remote server, such as via direct or indirect wireless communication or data transmission from a smart home controller, mobile device, or other customer computing device, after a customer affirmatively consents or otherwise opts-in to an insurance discount, reward, or other program. The insurance provider may then analyze the data received with the customer's permission to provide benefits to the customer. As a result, risk averse customers may receive insurance discounts or other insurance cost savings based upon data that reflects low risk behavior and/or technology that mitigates or prevents risk to (i) insured assets, such as homes, personal belongings, or vehicles, and/or (ii) home or apartment occupants.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

A hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method, comprising:
obtaining, by one or more processors, training data including historical transcripts from a plurality of historical user interactions, and indications of workflow statuses associated with each of the historical transcripts;
training, by the one or more processors, a machine learning model to classify transcripts from user interactions based on workflow status using the training data;
applying, by the one or more processors, the trained machine learning model to a new transcript from a new user interaction in order to identify a workflow status associated with the new transcript;
generating, by the one or more processors, a message to a user associated with the new user interaction based on the identified workflow status associated with the new transcript from the new user interaction;
analyzing, by the one or more processors, the new transcript using a natural language processing algorithm to identify one or more triggers associated with the new transcript;
modifying, by the one or more processors, one or more parameters associated with the generated message to the user based on the one or more triggers associated with the new transcript; and
transmitting, by the one or more processors, the message to a device associated with the user.

2. The computer-implemented method of claim 1, wherein modifying the one or more parameters associated with the generated message to the user based on the one or more triggers associated with the new transcript includes modifying a timing parameter associated with the generated message to the user based on the one or more triggers associated with the new transcript; and
wherein transmitting the message to the device associated with the user includes scheduling the transmission of the message to the device associated with the user in accordance with the modified timing parameter.

3. The computer-implemented method of claim 1, wherein modifying the one or more parameters associated with the generated message to the user based on the one or more triggers associated with the new transcript includes modifying a communication channel parameter associated with the generated message to the user based on the one or more triggers associated with the new transcript; and
wherein transmitting the message to the device associated with the user includes utilizing a communication channel for the transmission of the message to the device associated with the user in accordance with the modified communication channel parameter.

4. The computer-implemented method of claim 1, wherein the new transcript from the new user interaction is a transcript of a conversation between a user and an automated virtual assistant.

5. The computer-implemented method of claim 1, wherein the new transcript from the new user interaction is a transcript of a live conversation between a user and another individual.

6. The computer-implemented method of claim 1, wherein the new transcript from the new user interaction is a transcript of a telephone user interaction.

7. The computer-implemented method of claim 1, wherein the new transcript from the new user interaction is a transcript of an email user interaction.

8. The computer-implemented method of claim 1, wherein the new transcript from the new user interaction is a transcript of a text message user interaction.

9. The computer-implemented method of claim 1, wherein the new transcript from the new user interaction is a transcript of an online chat user interaction.

10. A system comprising one or more processors, and a memory storing instructions that, when executed by the one or more processors, cause the one or more processors to:
obtain training data including historical transcripts from a plurality of historical user interactions, and indications of workflow statuses associated with each of the historical transcripts;
train a machine learning model to classify transcripts from user interactions based on workflow status using the training data;
apply the trained machine learning model to a new transcript from a new user interaction in order to identify a workflow status associated with the new transcript;
generate a message to a user associated with the new user interaction based on the identified workflow status associated with the new transcript from the new user interaction;
analyze the new transcript using a natural language processing algorithm to identify one or more triggers associated with the new transcript;
modify one or more parameters associated with the generated message to the user based on the one or more triggers associated with the new transcript; and
transmit the message to a device associated with the user.

11. The system of claim 10, wherein the instructions cause the one or more processors to modify the one or more parameters associated with the generated message to the user based on the one or more triggers associated with the new transcript by modifying a timing parameter associated with the generated message to the user based on the one or more triggers associated with the new transcript; and
wherein the instructions that cause the one or more processors to transmit the message to the device associated with the user include instructions for scheduling the transmission of the message to the device associated with the user in accordance with the modified timing parameter.

12. The system of claim 10, wherein the instructions cause the one or more processors to modify the one or more parameters associated with the generated message to the user based on the one or more triggers associated with the new transcript by modifying a communication channel parameter associated with the generated message to the user based on the one or more triggers associated with the new transcript; and
wherein the instructions that cause the one or more processors to transmit the message to the device associated with the user include instructions for utilizing a communication channel for the transmission of the message to the device associated with the user in accordance with the modified communication channel parameter.

13. A non-transitory, computer-readable medium storing instructions that, when executed by one or more processors, cause the one or more processors to:
obtain training data including historical transcripts from a plurality of historical user interactions, and indications of workflow statuses associated with each of the historical transcripts;
train a machine learning model to classify transcripts from user interactions based on workflow status using the training data;
apply the trained machine learning model to a new transcript from a new user interaction in order to identify a workflow status associated with the new transcript;
generate a message to a user associated with the new user interaction based on the identified workflow status associated with the transcript from the new user interaction;
analyze the new transcript using a natural language processing algorithm to identify one or more triggers associated with the new transcript;
modify one or more parameters associated with the generated message to the user based on the one or more triggers associated with the new transcript; and
transmit the message to a device associated with the user.

14. The non-transitory, computer-readable medium of claim 13, wherein the instructions cause the one or more processors to modify the one or more parameters associated with the generated message to the user based on the one or more triggers associated with the new transcript by modifying a timing parameter associated with the generated message to the user based on the one or more triggers associated with the new transcript; and
wherein the instructions that cause the one or more processors to transmit the message to the device associated with the user include instructions for scheduling the transmission of the message to the device associated with the user in accordance with the modified timing parameter.

15. The non-transitory, computer-readable medium of claim 13, wherein the instructions cause the one or more processors to modify the one or more parameters associated with the generated message to the user based on the one or more triggers associated with the new transcript by modifying a communication channel parameter associated with the generated message to the user based on the one or more triggers associated with the new transcript; and
wherein the instructions that cause the one or more processors to transmit the message to the device associated with the user include instructions for utilizing a communication channel for the transmission of the message to the device associated with the user in accordance with the modified communication channel parameter.

16. The non-transitory, computer-readable medium of claim 13, wherein the new transcript from the new user interaction is a transcript of a conversation between a user and an automated virtual assistant.

17. The non-transitory, computer-readable medium of claim 13, wherein the new transcript from the new user interaction is a transcript of a live conversation between a user and another individual.

18. The non-transitory, computer-readable medium of claim 13, wherein the new transcript from the new user interaction is a transcript of a telephone user interaction.

19. The non-transitory, computer-readable medium of claim 13, wherein the new transcript from the new user interaction is a transcript of an email user interaction.

20. The non-transitory, computer-readable medium of claim 13, wherein the new transcript from the new user interaction is a transcript of a text message user interaction.
